(19) United States
(12) Patent Application Publication
(10) Pub. No.: US 2026/0267069 A1
(43) Pub. Date: Sep. 10, 2026

(54) COATING REMOVER

(71) Applicant: SUMITOMO ELECTRIC OPTIFRONTIER CO., LTD., Kanagawa (JP)

(72) Inventors: Yuta RYONO, Kanagawa (JP); Hiroshi NAKAMURA, Kanagawa (JP); Atsushi KUWAHARA, Kanagawa (JP); Ryuichiro SATO, Kanagawa (JP)

(21) Appl. No.: 19/167,410

(22) PCT Filed: Jun. 4, 2024
(86) PCT No.: PCT/JP2024/020302

§ 371 Date: Sep. 22, 2025

(30) Foreign Application Priority Data
Apr. 5, 2023 (JP) 2023-061742

(51) Int. Cl. G02B 6/245; B26D 7/10

(52) U.S. Cl. CPC G02B 6/245; B26D 7/10

(57) ABSTRACT

A coating remover according to one embodiment includes an optical fiber placement portion on which an optical fiber core including a coating is placed, and which includes a first blade that cuts into the coating; a lid portion openable and closable relative to the optical fiber placement portion and including a second blade that faces the first blade when the lid portion is closed onto the optical fiber placement portion; and a light diffusion portion that irradiates the optical fiber core, which is placed on the optical fiber placement portion, with diffused light. The optical fiber placement portion has a placement surface on which the optical fiber core is placed, and the light diffusion portion irradiates the placement surface obliquely downward with the diffused light.

### TECHNICAL FIELD

The present disclosure relates to a coating remover.

Priority is claimed on Japanese Patent Application No. 2023-061742, filed on Apr. 5, 2023, the entire content of which is incorporated herein by reference.

### BACKGROUND ART

Patent Literature 1 describes a coating removal device. The coating removal device includes a holding portion that holds an optical fiber, and a device main body configured separately from the holding portion. A length of the device main body in a front-to-rear direction is longer than a length of the holding portion in the front-to-rear direction. The device main body includes a heating portion for heating a coating, and a main body portion including an operation receiving portion and a control board. The main body portion includes a lighting portion that is an LED lamp provided on a front surface, and a reflecting portion that is provided on a heating lid of the heating portion and that reflects light from the lighting portion upward.

Patent Literature 2 describes a coating removal device including a heater for heating the coating of an optical fiber. The coating removal device includes a heating portion for heating the coating of the optical fiber, and a grip portion that is a portion of the coating removal device that is gripped. The heating portion includes a pair of blades for removing the coating. The heating portion includes a heating side main body including the blades and the heater. An end portion of the optical fiber is placed on the heater, and the heater heats the end portion of the optical fiber that is placed.

Patent Literature 3 describes a coating remover. The coating remover includes an optical fiber holder holding portion and a main body portion including a coating removal portion and an operation portion. The coating removal portion includes an optical fiber placement portion on which an optical fiber core is placed, and a lid portion provided to be openable and closable relative to the optical fiber placement portion. The optical fiber placement portion includes a heating portion including a heater for heating a coating portion of the optical fiber core.

### CITATION LIST

### Patent Literature

Patent Literature 1: Japanese Unexamined Patent Publication No. 2022-30569
Patent Literature 2: Japanese Unexamined Patent Publication No. 2018-138970
Patent Literature 3: Japanese Unexamined Patent Publication No. 2015-184647

### SUMMARY OF INVENTION

A coating remover according to the present disclosure includes an optical fiber placement portion on which an optical fiber core including a coating is placed, and which includes a first blade that cuts into the coating; a lid portion openable and closable relative to the optical fiber placement portion and including a second blade that faces the first blade when the lid portion is closed onto the optical fiber placement portion; and a light diffusion portion that irradiates the optical fiber core, which is placed on the optical fiber placement portion, with diffused light. The optical fiber placement portion has a placement surface on which the optical fiber core is placed, and the light diffusion portion irradiates the placement surface obliquely downward with the diffused light.

### BRIEF DESCRIPTION OF DRAWINGS

FIG. 1 is a perspective view showing a coating remover according to one embodiment.

FIG. 2 is a perspective view showing a state where an optical fiber holder is disposed in a holder holding portion of the coating remover of FIG. 1.

FIG. 3 is a perspective view showing the holder holding portion and a main body portion of the coating remover of FIG. 1.

FIG. 4 is a cross-sectional view showing a light diffusion portion of the coating remover of FIG. 1.

FIG. 5 is a perspective view showing a substrate and the light diffusion portion of the coating remover of FIG. 1.

FIG. 6 is a front view showing the light diffusion portion of FIG. 5.

FIG. 7 is a rear view showing the light diffusion portion of FIG. 5.

### DESCRIPTION OF EMBODIMENTS

### Technical Problem

When the coating is removed from the optical fiber core in the coating remover, the optical fiber core is placed on the heater of the optical fiber placement portion. By the way, the removal of the coating from the optical fiber core may be performed in a dark place. In dark places, the optical fiber core placed on the optical fiber placement portion may not be well visible. When the coating is removed from a plurality of the optical fiber cores such as intermittent ribbons, the plurality of optical fiber cores may have to be arranged on the optical fiber placement portion in order to avoid breakage. Therefore, it is required that the visibility of the optical fiber core placed on the optical fiber placement portion is improved.

### Advantageous Effects of Invention

According to the present disclosure, the visibility of the optical fiber core placed on the optical fiber placement portion can be improved.

### Description of Embodiment of Present Disclosure

An embodiment of the present disclosure will be listed and described. A coating remover according to one embodiment includes (1) an optical fiber placement portion on which an optical fiber core including a coating is placed, and which includes a first blade that cuts into the coating; a lid portion openable and closable relative to the optical fiber placement portion and including a second blade that faces the first blade when the lid portion is closed onto the optical fiber placement portion; and a light diffusion portion that irradiates the optical fiber core, which is placed on the optical fiber placement portion, with diffused light. The optical fiber placement portion has a placement surface on which the optical fiber core is placed, and the light diffusion portion irradiates the placement surface obliquely downward with the diffused light.

The coating remover includes the optical fiber placement portion and the lid portion. The optical fiber placement portion includes the first blade that cuts into the coating, and the lid portion includes the second blade facing the first blade. The optical fiber placement portion has the placement surface on which the optical fiber core including the coating is placed. The coating remover includes the light diffusion portion that irradiates the optical fiber core, which is placed on the placement surface of the optical fiber placement portion, with the diffused light. When the light diffusion portion irradiates the optical fiber core with the diffused light, the optical fiber core can be evenly irradiated with the light compared to when the optical fiber core is irradiated with light with strong straightness such as light from an LED. Therefore, the visibility of the optical fiber core placed on the placement surface can be improved. The light diffusion portion irradiates the placement surface of the optical fiber placement portion obliquely downward with the diffused light. When the placement surface is irradiated obliquely downward with the diffused light, the visibility of the optical fiber core placed on the placement surface can be improved compared to when the placement surface is irradiated horizontally with the diffused light.
(2) In (1) above, the light diffusion portion may be provided in a wall portion aligned with the optical fiber placement portion along a direction in which the optical fiber core placed on the optical fiber placement portion extends. The light diffusion portion may be disposed in a hole recessed in the wall portion in a direction away from the optical fiber placement portion. In this case, since the light diffusion portion is disposed in the hole formed in the wall portion, water or the like can be prevented from entering the light diffusion portion. Therefore, the light diffusion portion can be protected from moisture and the like.
(3) In (2) above, the light diffusion portion may include a first protruding portion protruding in the direction away from the optical fiber placement portion and a second protruding portion protruding downward, and each of the first protruding portion and the second protruding portion may enter the hole. In this case, since each of the first protruding portion and the second protruding portion of the light diffusion portion enters the hole of the wall portion, the light diffusion portion can be firmly fixed to the wall portion.
(4) In (2) or (3) above, the hole may have a lower surface extending below the light diffusion portion, and the lower surface may extend obliquely downward as the lower surface becomes spaced apart from the light diffusion portion. In this case, even when water droplets or the like enter the hole, the water droplets or the like flow obliquely downward along the lower surface so as to become spaced apart from the light diffusion portion, and exit from the hole. Therefore, the light diffusion portion can be protected from water droplets and the like.

### Details of Embodiment of Present Disclosure

A specific example of a coating remover according to an embodiment of the present disclosure will be described below with reference to the drawings. The present invention is not limited to the example, but is set forth by the claims, and is intended to include all modifications within the claims and their equivalents. In the description of the drawings, the same or corresponding elements are denoted by the same reference signs, and duplicate descriptions will be omitted as appropriate. The drawings may be partially depicted in a simplified or exaggerated manner for ease of understanding, and dimensional ratios and the like are not limited to those shown in the drawings.

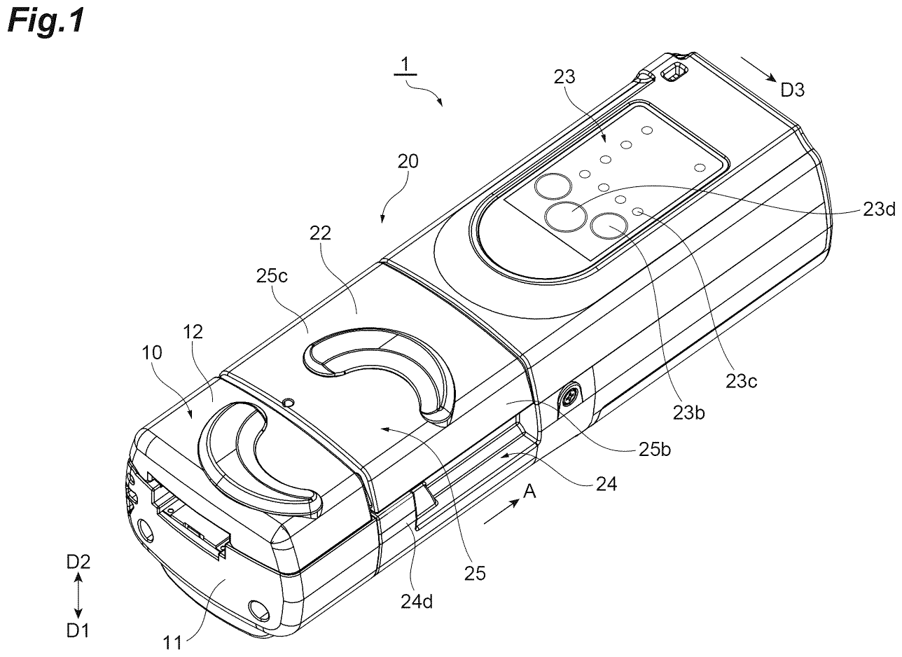

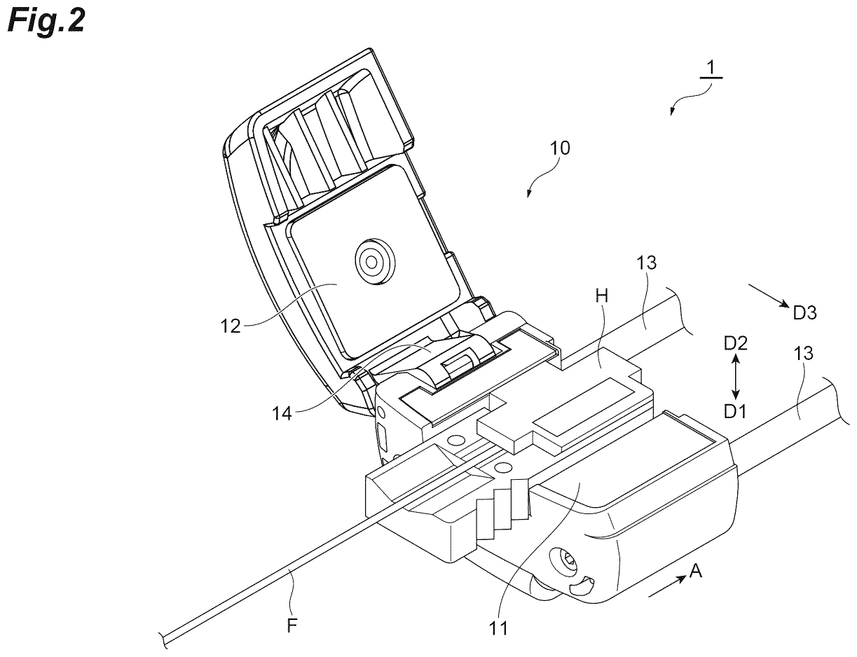

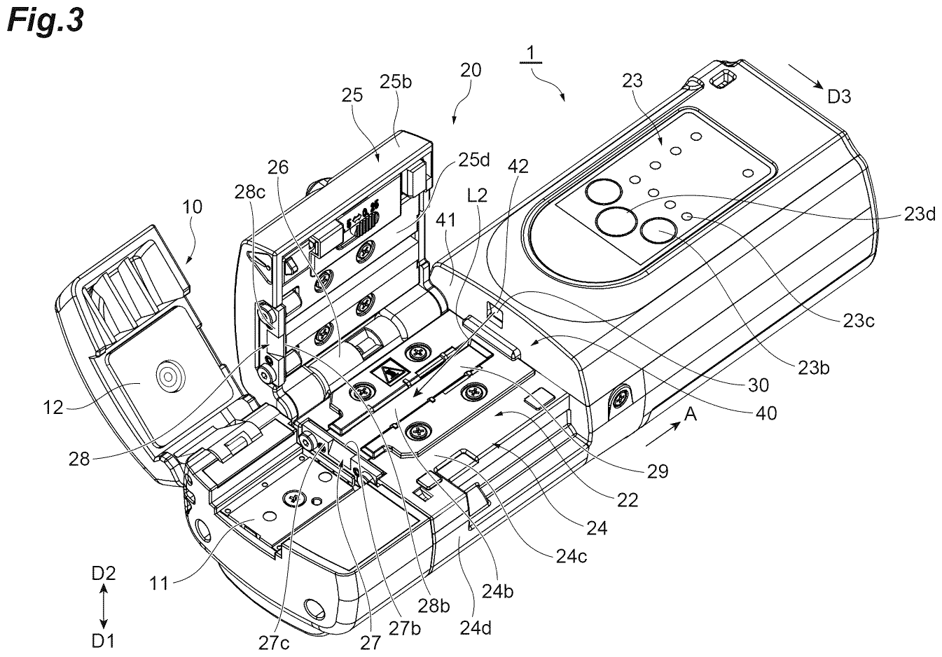

FIG. 1 is a perspective view showing a coating remover 1 according to one embodiment. FIG. 2 is a perspective view showing the coating remover 1 on which an optical fiber holder H that holds an optical fiber core F from which the coating remover 1 removes a coating is placed. FIG. 3 is a perspective view showing an internal structure of the coating remover 1 shown in FIG. 1. The optical fiber core F includes, for example, a glass fiber and a resin coating that covers the glass fiber.

The coating remover 1 is a device that removes the coating from the optical fiber core F. A diameter of the optical fiber core F (outer diameter of the coating of the optical fiber core F) is, for example, 180 μm or more and 400 μm or less. The optical fiber holder H may hold a plurality of the optical fiber cores F, and the coating remover 1 may collectively perform coating removal on the plurality of optical fiber cores F. The plurality of optical fiber cores F may be optical fiber ribbon cores such as intermittent ribbons.

For example, the coating remover 1 includes a holder holding portion 10 and a main body portion 20. The holder holding portion 10 includes a holder placement portion 11 on which the optical fiber holder H that holds the optical fiber core F is placed, and a lid portion 12 that is openable and closable relative to the holder placement portion 11. The optical fiber holder H holds an end portion of the optical fiber core F. The length of a portion of the optical fiber core F from which the coating is removed is adjusted by adjusting the position where the optical fiber holder H holds the optical fiber core F. In the following description, a direction in which the lid portion 12 is closed onto the holder placement portion 11 is referred to as a first direction D1, and a direction in which the lid portion 12 is opened from the holder placement portion 11 is referred to as a second direction D2. For example, the coating remover 1 extends in an extending direction A that is a direction in which the optical fiber core F extends, and has a width in a third direction D3 that is a direction intersecting both the first direction D1 and the second direction D2.

The holder holding portion 10 and the main body portion 20 are aligned along the extending direction A. The main body portion 20 is connected to an end portion of the holder holding portion 10 in the extending direction A. The holder holding portion 10 includes a slide shaft 13 extending to the main body portion 20. The holder holding portion 10 includes two slide shafts 13, and the two slide shafts 13 are aligned along the third direction D3. The main body portion 20 has sliding holes into which the holder holding portion 10 is inserted. The main body portion 20 has two sliding holes, and the two sliding holes are aligned along the third direction D3. The slide shafts 13 are slidably inserted into the sliding holes formed in the main body portion 20. Accordingly, the holder holding portion 10 is slidable in a direction toward the main body portion 20 and in a direction away from the main body portion 20. Hereinafter, the direction in which the holder holding portion 10 becomes spaced apart from the main body portion 20 may be referred to as the front, forward, or front side, and the direction in which the holder holding portion 10 approaches the main body portion 20 may be referred to as the rear, rearward, or rear side.

The holder holding portion 10 holds the optical fiber holder H that holds the optical fiber core F. The holder holding portion 10 includes a hinge 14 that allows the lid portion 12 to be opened and closed relative to the holder placement portion 11. The hinge 14 extends along the extending direction A at an end portion of the holder holding portion 10 opposite to the third direction D3. The lid portion 12 is openable and closable relative to the holder placement portion 11 by rotating the lid portion 12 about the hinge 14. The holder holding portion 10 holds the optical fiber holder H placed on the holder placement portion 11 by sandwiching the optical fiber holder H between the holder placement portion 11 and the lid portion 12.

The main body portion 20 includes a coating removal portion 22 that is portion for removing the coating from the optical fiber core F, and an operation portion 23 for operating the coating removal by the coating removal portion 22. The coating removal portion 22 and the operation portion 23 are aligned along the extending direction A. The coating removal portion 22 is located between the operation portion 23 and the holder holding portion 10. The coating removal portion 22 includes an optical fiber placement portion 24 on which the optical fiber core F is placed, and a lid portion 25 that is openable and closable relative to the optical fiber placement portion 24. The lid portion 25 is closed onto the optical fiber placement portion 24 by moving in the first direction D1. The lid portion 25 is opened from the optical fiber placement portion 24 by moving in the second direction D2.

The coating removal portion 22 includes a hinge 26 that allows the lid portion 25 to be opened and closed relative to the optical fiber placement portion 24. The hinge 26 extends along the extending direction A at an end portion of the main body portion 20 opposite to the third direction D3. The lid portion 25 is openable and closable relative to the optical fiber placement portion 24 by rotating the lid portion 25 about the hinge 26. The main body portion 20 holds the optical fiber core F placed on the optical fiber placement portion 24 by sandwiching the optical fiber core F between the optical fiber placement portion 24 and the lid portion 25.

For example, the optical fiber placement portion 24 includes a side surface portion 24d facing the third direction D3 and a top surface portion 24c facing the lid portion 25 that is closed. The optical fiber placement portion 24 includes a first blade 27 that cuts into the coating of the optical fiber core F. The first blade 27 is disposed on the front side of the optical fiber placement portion 24. The first blade 27 includes, for example, a first blade portion 27b that cuts into the coating, and a support portion 27c that supports the first blade portion 27b. The first blade portion 27b and the support portion 27c are made of, for example, metal. The first blade portion 27b and the support portion 27c are integrally formed.

For example, the lid portion 25 includes a side surface portion 25b facing the third direction D3 when closed; a top surface portion 25c facing the second direction D2 when closed; and an inner surface portion 25d facing the top surface portion 24c of the optical fiber placement portion 24 when closed. The lid portion 25 includes a second blade 28 that cuts into the coating of the optical fiber core F. The second blade 28 is disposed on the front side of the lid portion 25. The second blade 28 is disposed at a position where the second blade 28 faces the first blade 27 along the first direction D1 when the lid portion 25 is closed onto the optical fiber placement portion 24. The second blade 28 includes a second blade portion 28b that cuts into the coating, and a support portion 28c that supports the second blade portion 28b. The second blade portion 28b and the support portion 28c are made of, for example, metal. The second blade portion 28b and the support portion 28c are integrally formed.

The first blade 27 and the second blade 28 face each other along the first direction D1 when the lid portion 25 is closed onto the optical fiber placement portion 24. A cut is made in the coating of the optical fiber core F located between the first blade portion 27b and the second blade portion 28b. The distance between the first blade portion 27b and the second blade portion 28b is set such that the first blade portion 27b and the second blade portion 28b come into contact with the coating of the optical fiber core F, but the first blade portion 27b and the second blade portion 28b do not come into contact with the glass fiber of the optical fiber core F.

The optical fiber placement portion 24 includes a heater 29. The heater 29 is disposed behind the first blade 27. For example, the heater 29 forms a placement surface 24b of the optical fiber placement portion 24 on which the optical fiber core F is placed. The heater 29 receives a supply of electric power, and heats the coating of the optical fiber core F. The supply of electric power to the heater 29 is controlled by a heater power switch (not shown) that turns on when the lid portion 25 is closed onto the optical fiber placement portion 24 and turns off when the lid portion 25 is opened from the optical fiber placement portion 24. The heater 29 performs heating when the lid portion 25 is closed onto the optical fiber placement portion 24.

The operation portion 23 is disposed behind the coating removal portion 22. The operation portion 23 includes a switch 23b for turning a power source on and off or regulating the temperature of the heater 29 and a display portion 23c indicating the state of the heater 29 (for example, the heating temperature and the on/off state of the heater 29). The display portion 23c displays, for example, that the optical fiber core F is heated by the heater 29 and the temperature of the optical fiber core F has reached a maximum temperature for removing the coating. For example, a battery (not shown) that supplies electric power to the heater 29 is built into the operation portion 23.

When the coating is removed from the optical fiber core F using the coating remover 1, the optical fiber core F is placed on the heater 29 (placement surface 24b) of the optical fiber placement portion 24. The removal of the coating from the optical fiber core F is performed in a dark place, and in dark places, it may occur that the optical fiber core F placed on the optical fiber placement portion 24 is difficult to see. When the coating is removed from the plurality of optical fiber cores F such as intermittent ribbons, the plurality of optical fiber cores F may have to be arranged such that the plurality of optical fiber cores F are aligned along the third direction D3. The coating remover 1 according to the present embodiment includes a light diffusion portion 30, and therefore, the visibility of the optical fiber core F placed on the placement surface 24b is enhanced. Hereinafter, the light diffusion portion 30 will be described in detail.

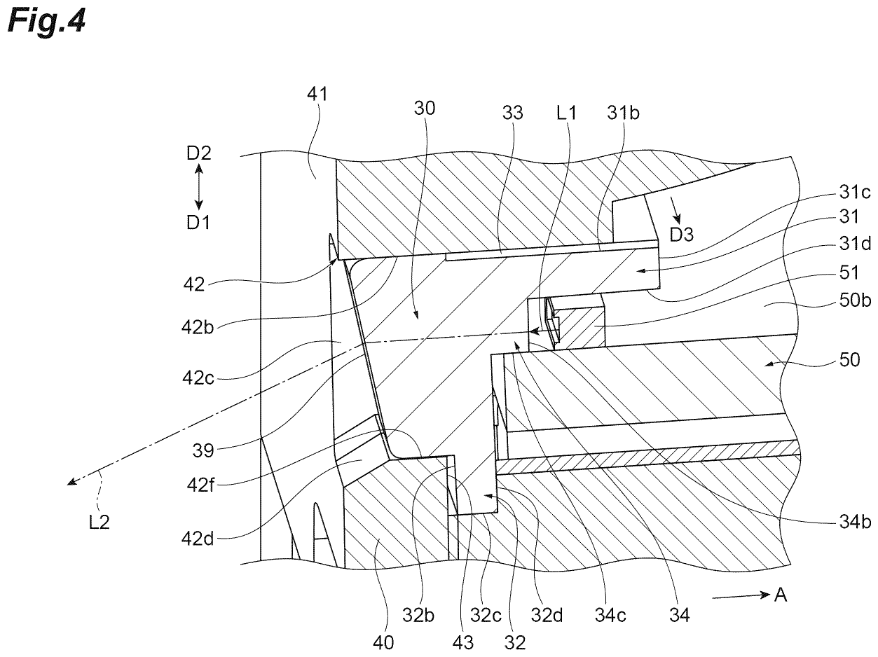

FIG. 4 is a cross-sectional view of the light diffusion portion 30 taken along a plane extending in both the extending direction A and the first direction D1. As shown in FIGS. 3 and 4, the light diffusion portion 30 is provided in a wall portion 40 aligned with the optical fiber placement portion 24 along the extending direction A. For example, the wall portion 40 has a wall surface 41 facing the lid portion 25 of the operation portion 23. The wall surface 41 extends along the first direction D1 and the third direction D3.

The light diffusion portion 30 is disposed in a hole 42 recessed in the wall portion 40 in a direction away from the optical fiber placement portion 24 (for example, rearward). For example, the hole 42 penetrates through the wall portion 40 in the extending direction A. The hole 42 has an upper surface 42b extending from the wall surface 41 along the extending direction A and extending in both the extending direction A and the third direction D3, and a pair of inner surfaces 42c extending in both the first direction D1 and the extending direction A and facing each other along the third direction D3. The hole 42 has a lower surface 42d extending obliquely upward from the wall surface 41 and extending along the third direction D3, and an extending surface 42f extending along the extending direction A from an end portion of the lower surface 42d opposite to the wall surface 41. The hole 42 is defined by the upper surface 42b, the pair of inner surfaces 42c, the lower surface 42d, and the extending surface 42f.

For example, the coating remover 1 includes a substrate 50 built into the operation portion 23. An element that processes electrical signals for controlling each part of the coating remover 1 in response to an operation on the operation portion 23 is mounted on the substrate 50. A light source 51 is mounted on the substrate 50. For example, the light source 51 is mounted on an upper surface 50b of the substrate 50. For example, the light source 51 is an LED light source that emits LED light. The operation portion 23 includes, for example, a light on/off switch 23d for turning on and off the light of the light diffusion portion 30. As one example, the light on/off switch 23d is a tactile switch. For example, when the light on/off switch 23d is turned on, the element of the substrate 50 outputs a control signal to the light source 51. At this time, the light source 51 emits light upon receiving the control signal, and irradiates the light diffusion portion 30 with light L1. As one example, the light L1 is a straight light.

For example, the light diffusion portion 30 is made of acrylic or polycarbonate. As one example, the light diffusion portion 30 includes diffusion particles that diffuse the light L1. The light diffusion portion 30 converts the light L1 from the light source 51 into diffused light L2, and irradiates the optical fiber core F, which is placed on the optical fiber placement portion 24, with the diffused light L2. The light diffusion portion 30 irradiates the placement surface 24b of the optical fiber placement portion 24 obliquely downward with the diffused light L2. The optical axis of the diffused light L2 extends obliquely downward from the light diffusion portion 30 toward the placement surface 24b.

For example, the optical axis of the diffused light L2 extends forward (to a location closer to the holder holding portion 10) beyond the center of the placement surface 24b in the extending direction A. In this case, a portion of the placement surface 24b which is closer to the holder holding portion 10 can be brightened. As one example, the color of the diffused light L2 is milky white. For example, the light diffusion portion 30 is fixed to the upper surface 42b, and is in contact with the extending surface 42f. For example, the light diffusion portion 30 is in close contact with the upper surface 42b and the extending surface 42f. In this case, water or the like can be prevented from entering the hole 42. As one example, the light diffusion portion 30 is fixed to the hole 42 via an adhesive member 33. The adhesive member 33 is, for example, a double-sided tape. In a state where the light diffusion portion 30 has entered the hole 42, the lower surface 42d extends obliquely downward as the lower surface 42d becomes spaced apart from the light diffusion portion 30.

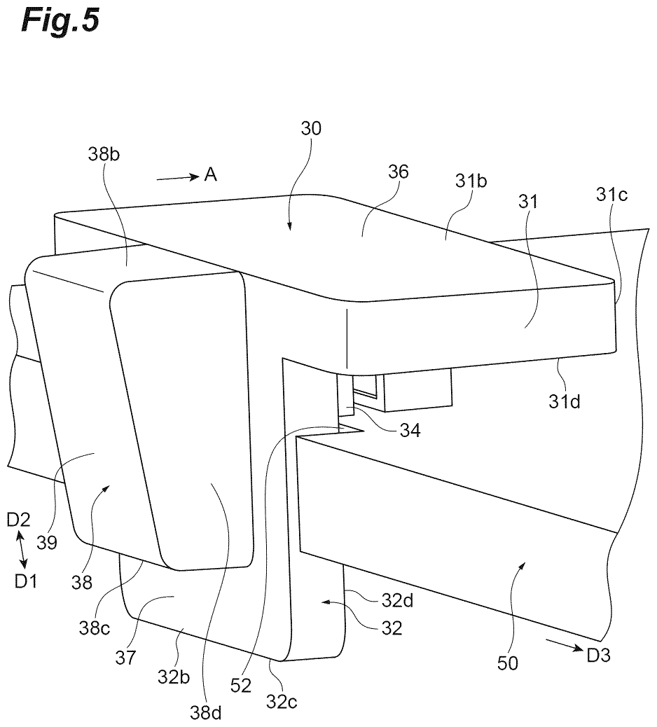

FIG. 5 is a perspective view showing the light diffusion portion 30 and the substrate 50. As shown in FIGS. 4 and 5, the light diffusion portion 30 includes a first protruding portion 31 protruding in the direction away from the optical fiber placement portion 24 and a second protruding portion 32 protruding downward. Each of the first protruding portion 31 and the second protruding portion 32 enters the hole 42. The first protruding portion 31 has an upper surface 31b on which the adhesive member 33 is placed; an end surface 31c extending in both the first direction D1 and the third direction D3 at an end portion of the first protruding portion 31 in the extending direction A; and a lower surface 31d facing away from the upper surface 31b. The lower surface 31d faces the light source 51. The light source 51 is provided below the lower surface 31d. The second protruding portion 32 has a first surface 32b facing an inner surface 43 of the wall portion 40; an end surface 32c extending in both the extending direction A and the third direction D3 at a lower end of the first surface 32b; and a second surface 32d facing away from the first surface 32b.

The substrate 50 includes recess 52 recessed in a direction away from the optical fiber placement portion 24 (for example, rearward). A part of the light diffusion portion 30 enters the recess 52. For example, the light diffusion portion 30 includes a step portion 34 placed on the upper surface 50b of the substrate 50. The step portion 34 has a first step surface 34b extending downward from the lower surface 31d of the first protruding portion 31, and a second step surface 34c extending from a lower end of the first step surface 34b in a direction toward the optical fiber placement portion 24 (for example, forward) and the third direction D3. The first step surface 34b faces the light source 51 along the extending direction A. The first step surface 34b is a light incident surface on which the light L1 from the light source 51 is incident. For example, a direction in which the optical axis of the light L1 extends coincides with the extending direction A. For example, the light diffusion portion 30 enters the recess 52, and is fixed to the substrate 50 in a state where the second step surface 34c is placed on the upper surface 50b of the substrate 50.

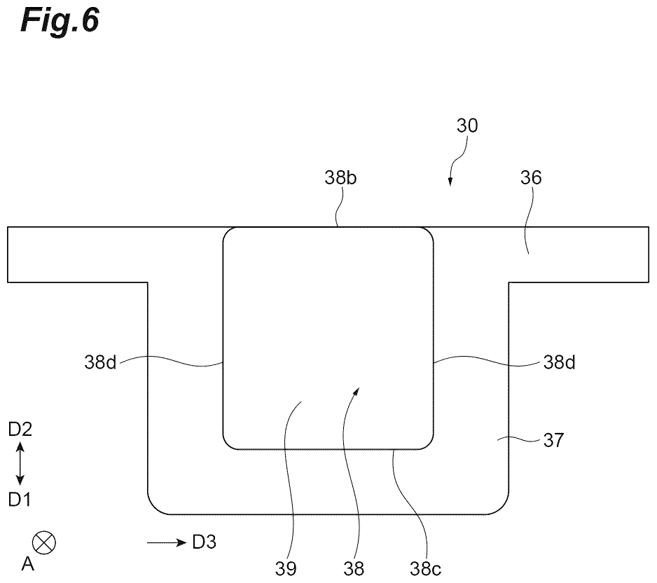

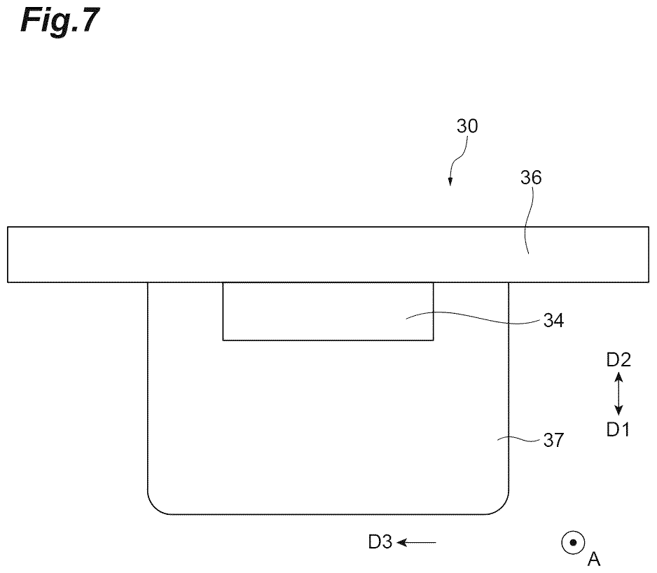

FIG. 6 is a front view of the light diffusion portion 30 when the light diffusion portion 30 is viewed along the extending direction A. FIG. 7 is a rear view of the light diffusion portion 30. As shown in FIGS. 5, 6 and 7, the light diffusion portion 30 has a T-shape when viewed along the extending direction A. For example, the light diffusion portion 30 includes an upper surface portion 36 including the first protruding portion 31; a side surface portion 37 including the second protruding portion 32; and a light emitting portion 38 that emits the diffused light L2. The upper surface portion 36 has a plate shape extending in both the extending direction A and the third direction D3 and having a thickness in the first direction D1. The side surface portion 37 extends downward from an end portion of the upper surface portion 36 in a direction toward the optical fiber placement portion 24. The side surface portion 37 has a plate shape extending in both the first direction D1 and the third direction D3 and having a thickness in the extending direction A.

The light emitting portion 38 protrudes from the upper surface portion 36 and the side surface portion 37 in the direction toward the optical fiber placement portion 24. The light emitting portion 38 has an inclined surface 39 extending along the third direction D3 and inclined with respect to the first direction D1 so as to become spaced apart from the optical fiber placement portion 24 as the inclined surface 39 extends downward. The inclined surface 39 is a light emitting surface from which the diffused light L2 is emitted. The light L1 that is incident on the light diffusion portion 30 from the first step surface 34b along the extending direction A is converted into the diffused light L2 inside the light diffusion portion 30, and the diffused light L2 is emitted obliquely downward from the inclined surface 39 (see FIG. 4). As one example, the inclined surface 39 has a rectangular shape.

For example, the light emitting portion 38 has an upper surface 38b extending from the upper surface portion 36 to an upper end of the inclined surface 39; a lower surface 38c extending from the side surface portion 37 to a lower end of the inclined surface 39; and a pair of side surfaces 38d that connect the upper surface 38b and the lower surface 38c to each other. For example, the upper surface 38b and the lower surface 38c have a rectangular shape. The pair of side surfaces 38d are aligned along the third direction D3. For example, each of the side surfaces 38d has a trapezoidal shape, the width of which becomes narrower as the side surface 38d extends downward.

Next, effects obtained from the coating remover 1 according to the present embodiment will be described. The coating remover 1 includes the optical fiber placement portion 24 and the lid portion 25. The optical fiber placement portion 24 includes the first blade 27 that cuts into the coating, and the lid portion 25 includes the second blade 28 facing the first blade 27. The optical fiber placement portion 24 has the placement surface 24b on which the optical fiber core F including the coating is placed. The coating remover 1 includes the light diffusion portion 30 that irradiates the optical fiber core F, which is placed on the placement surface 24b of the optical fiber placement portion 24, with the diffused light L2. When the light diffusion portion 30 irradiates the optical fiber core F with the diffused light L2, the optical fiber core F can be evenly irradiated with the light compared to when the optical fiber core F is irradiated with light with strong straightness such as light from an LED. Therefore, the visibility of the optical fiber core F placed on the placement surface 24b can be improved. The light diffusion portion 30 irradiates the placement surface 24b of the optical fiber placement portion 24 obliquely downward with the diffused light L2. When the placement surface 24b is irradiated obliquely downward with the diffused light L2, the visibility of the optical fiber core F placed on the placement surface 24b can be improved compared to when the placement surface 24b is irradiated horizontally with the diffused light L2.

As described above, the light diffusion portion 30 may be provided in the wall portion 40 aligned with the optical fiber placement portion 24 along the extending direction A that is a direction in which the optical fiber core F placed on the optical fiber placement portion 24 extends. The light diffusion portion 30 may be disposed in the hole 42 recessed in the wall portion 40 in the direction away from the optical fiber placement portion 24. In this case, since the light diffusion portion 30 is disposed in the hole 42 formed in the wall portion 40, water or the like can be prevented from entering the light diffusion portion 30. Therefore, the light diffusion portion 30 can be protected from moisture and the like.

As described above, the light diffusion portion 30 may include the first protruding portion 31 protruding in the direction away from the optical fiber placement portion 24 and the second protruding portion 32 protruding downward, and each of the first protruding portion 31 and the second protruding portion 32 may enter the hole 42. In this case, since each of the first protruding portion 31 and the second protruding portion 32 of the light diffusion portion 30 enters the hole 42 of the wall portion 40, the light diffusion portion 30 can be firmly fixed to the wall portion 40.

As described above, the hole 42 may have the lower surface 42d extending below the light diffusion portion 30, and the lower surface 42d may extend obliquely downward as the lower surface 42d becomes spaced apart from the light diffusion portion 30. In this case, even when water droplets or the like enter the hole 42, the water droplets or the like flow obliquely downward along the lower surface 42d so as to become spaced apart from the light diffusion portion 30, and exit from the hole 42. Therefore, the light diffusion portion 30 can be protected from water droplets and the like.

The embodiment of the coating remover according to the present disclosure has been described above. However, the present invention is not limited to the embodiment described above. It will be easily understood by those skilled in the art that various modifications and changes can be made to the present invention within the scope of the concept described in the claims. For example, the shape, size, number, material, and disposition mode of each part of the coating remover can be changed as appropriate without departing from the scope of the concept. For example, the shapes of the light diffusion portion and the wall portion are not limited to the shapes of the light diffusion portion 30 and the wall portion 40 described above, and can be changed as appropriate.

### REFERENCE SIGNS LIST

1: coating remover, 10: holder holding portion, 11: holder placement portion, 12: lid portion, 13: slide shaft, 14: hinge, 20: main body portion, 22: coating removal portion, 23: operation portion, 23b: switch, 23c: display portion, 23d: light on/off switch, 24: optical fiber placement portion, 24b: placement surface, 24c: top surface portion, 24d: side surface portion, 25: lid portion, 25b: side surface portion, 25c: top surface portion, 25d: inner surface portion, 26: hinge, 27: first blade, 27b: first blade portion, 27c: support portion, 28: second blade, 28b: second blade portion, 28c: support portion, 29: heater, 30: light diffusion portion, 31: first protruding portion, 31b: upper surface, 31c: end surface, 31d: lower surface, 32: second protruding portion, 32b: first surface, 32c: end surface, 32d: second surface, 33: adhesive member, 34: step portion, 34b: first step surface, 34c: second step surface, 36: upper surface portion, 37: side surface portion, 38: light emitting portion, 38b: upper surface, 38c: lower surface, 38d: side surface, 39: inclined surface, 40: wall portion, 41: wall surface, 42: hole, 42b: upper surface, 42c: inner surface, 42d: lower surface, 42f: extending surface, 43: inner surface, 50: substrate, 50b: upper surface, 51: light source, 52: recess, A: extending direction, D1: first direction, D2: second direction, D3: third direction, F: optical fiber core, H: optical fiber holder, L1: light, L2: diffused light.

What is claimed is:

1. A coating remover, comprising:
an optical fiber placement portion on which an optical fiber core including a coating is placed, and which includes a first blade that cuts into the coating;
a lid portion openable and closable relative to the optical fiber placement portion and including a second blade that faces the first blade when the lid portion is closed onto the optical fiber placement portion; and
a light diffusion portion that irradiates the optical fiber core, which is placed on the optical fiber placement portion, with diffused light,
wherein the optical fiber placement portion has a placement surface on which the optical fiber core is placed, and
the light diffusion portion irradiates the placement surface obliquely downward with the diffused light.

2. The coating remover according to claim 1,
wherein the light diffusion portion is provided in a wall portion aligned with the optical fiber placement portion along a direction in which the optical fiber core placed on the optical fiber placement portion extends, and
the light diffusion portion is disposed in a hole recessed in the wall portion in a direction away from the optical fiber placement portion.

3. The coating remover according to claim 2,
wherein the light diffusion portion includes a first protruding portion protruding in the direction away from the optical fiber placement portion and a second protruding portion protruding downward, and
each of the first protruding portion and the second protruding portion enters the hole.

4. The coating remover according to claim 2,
wherein the hole has a lower surface extending below the light diffusion portion, and the lower surface extends obliquely downward as the lower surface becomes spaced apart from the light diffusion portion.
